(19) United States
(12) Patent Application Publication
(10) Pub. No.: US 2008/0060037 A1
(43) Pub. Date: Mar. 6, 2008

(54) WEB-ENHANCED TELEVISION EXPERIENCE

(75) Inventor: Scott A. Isaacson, Kamuela, HI (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 11/468,684

(22) Filed: Aug. 30, 2006

(51) Int. Cl. H04N 7/173

(52) U.S. Cl. 725/113; 725/112

(57) ABSTRACT

A television (TV) broadcast signal is received and routed to a TV display. An audio data stream or ancillary data stream in the TV broadcast, (such as closed-captioning), is scanned to determine if a uniform resource locator (URL) is included in the TV broadcast. If a URL is identified in the TV broadcast, then the URL can be loaded in a web browser on a computer for a user to refer to when convenient.

### FIELD OF THE INVENTION

The invention pertains to television broadcasts, and more particularly to opening up an Internet browser to a URL during the television broadcast.

### BACKGROUND OF THE INVENTION

In the past, the television (TV) experience was simply that of a TV set receiving a broadcast over the airwaves and presenting the broadcast to viewers. Today, television has evolved. Cable and satellite transmission have dramatically increased the number of broadcast channels. In addition, televisions are often connected to video cassette recorders (VCRs), digital video recorders (DVRs), or other such devices that enable users to record TV programs and play them back at other times.

Television is frequently thought of as a source of entertainment. But television is also used to provide information. Even programs that are primarily designed to entertain can also include informative segments. For example, even though a sitcom is intended for entertainment, serious topics can be addressed in a sitcom. After raising the topic in the sitcom, a public service announcement can direct viewers to an organization to get involved or find out more information. Information is also presented on TV in the form of news programs. Finally, advertisements that occur during program breaks also present information to the viewer.

The information that is presented in a TV broadcast is limited by constraints of the format. For each channel of broadcast, the television limits what kind of data can be presented to the viewer to visual and auditory data. More and more, programmers and advertisers are supplementing the information that is broadcast over television by directing viewers to an Internet website for more information. For example, a TV advertiser might refer viewers to a website for information about a special offer. Or a TV show might itself have an associated website where viewers can find out more about characters on the show or even participate in a contest. It is the job of the viewer to then note the website, and at their convenience visit the website for more information. But by the time the viewer is finished watching the TV broadcast, the viewer has likely forgotten all about the website.

Accordingly, a need exists to be able to identify additional information available at a URL broadcast to a television display and load that URL in a web browser.

### SUMMARY OF THE INVENTION

A television (TV) broadcast signal is received and routed to a display. In addition, the TV broadcast is scanned to determine if a uniform resource locator (URL) is included in the TV broadcast. If a URL is identified in the TV broadcast, then the URL can be loaded in a web browser for a user to refer to when convenient.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a system including an enhanced TV device connected to a computer with a web browser, the enhanced TV device to detect a URL from a broadcast TV signal, according to an embodiment of the invention.

FIG. 2 shows components of the enhanced TV device shown in FIG. 1.

FIG. 3 shows the system of FIG. 2 with a configuration including triggering words and blocking words the enhanced TV device.

FIG. 4 shows a configuration interface for the enhanced TV device of FIG. 3 with words entered for triggering and blocking the display of a URL.

FIG. 5 shows a flowchart of the process of the enhanced TV device of FIG. 1 for detecting a URL in ancillary data of a TV broadcast signal, and loading the detected URL in a browser.

FIG. 6 shows a flowchart of the process of the enhanced TV device of FIG. 3 with a configuration including triggering words and blocking words.

### DETAILED DESCRIPTION OF THE PREFERRED EMBODIMENT

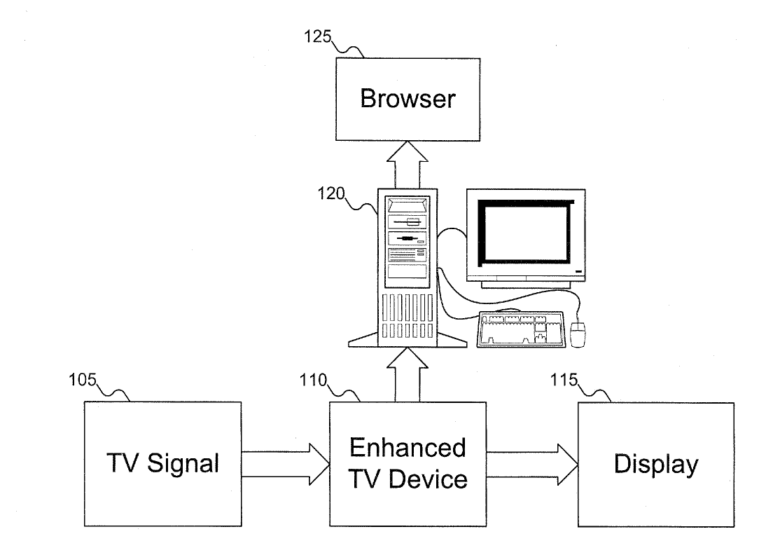

FIG. 1 shows a system including an enhanced television (TV) device connected to a computer with a web browser, the enhanced TV device to detect a uniform resource locator (URL) from a broadcast TV signal, according to an embodiment of the invention. As TV programmers try to incorporate new ways for advertisers to reach viewers, one technique advertisers use is to include a URL in the TV broadcast that directs users to a website where the user can get more information than is feasible to be broadcast over TV signal 105. In addition, using the Internet to deliver content allows the user to view the amount of content that the user considers valuable. Some users might want to see high level information at a single website, while others could spend hours following different links available from URL included in TV signal 105.

The URLs that are presented in TV signal 105 could be promotional URLs that inform TV viewers of a sale on an advertised product. Or a URL could be a link to a website for a particular program that is broadcast, where a fan of the program can see additional information about the program, such as behind the scenes footage, participate in chat about the program, etc. Television viewers that are not expecting a URL might not be able to write down or remember the name of a particular website. Also, the viewer might forget to look up the URL in the future. In addition, as digital video recorders become more popular, advertisers and television stations are concerned that viewers are skipping the advertisements. As a result, some advertisers are creating incentives for viewers to watch their commercials in slow motion, to see “hidden” features of the commercial, such as a promotional item that is obtained by visiting a particular website. While a viewer might prefer to fast forward through a commercial, the same viewer might also like to be able to refer to any supplemental information that is accessed at a website as identified by a URL.

By detecting the URLs that are in TV signal 105 and loading the URLs in a web browser, users do not have to pay such close attention to the broadcast to identify the URL in the first place. Even if a user happens to notice a URL that the user might be interested in following up with, by the time the user is finished watching the program, the user might have forgotten about the URL. If the URL is loaded in a user's browser, then the user is automatically reminded about the web content, because the content is already loaded on the user's computer.

Enhanced TV device 110 receives TV signal 105. TV signal 105 can be any type of content stream for televised display. For example, TV signal 105 can originate from TV transmitters, satellite, and recorded video (both digital and analog). Enhanced TV device 110 then routes TV signal 105 to display 115. Display 115 can be any display capable of presenting the content in TV signal 405 to a viewer. For example, display 405 can be a traditional television set, a computer monitor, a flat panel display, a portable display, a high definition display, a liquid crystal display, etc. Display 115 typically presents the audio and visual components of TV signal 105 to the viewer. In addition, other components of TV signal 105 can be accessed by the viewer. For example, TV signal 105 can include other ancillary data such as closed-captioning, where the audio portion of TV signal 105 is (entirely or in large part) presented as text that can be read on display 115.

In addition to routing TV signal 105 to display 115, enhanced TV device 110 scans the content broadcast in TV signal 105 to see if there is a URL included in the broadcast. An example of an existing technology that scans TV signal 105 is a product called the TV Guardian, which evaluates the closed-captioning stream of text, looking for profanity or sexually explicit language. In a similar manner, enhanced TV device 110 can scan the content in TV signal 105 for URLs or other computer-accessible information. A URL is identified when there is text that is in the format of a URL. For example, text that has words concatenated and separated with periods or forward slashes, as well as including a top level domain name, such as “.com” or “.edu”, etc., can be identified as a URL.

In another embodiment of the invention, enhanced TV device 110 can use a voice recognition component to identify a URL in an audio stream of TV signal. The audio signal is scanned for audio directing a user to a URL. The voice recognition module can receive sample audio for identifying a URL. For example, a user can train the enhanced TV device to recognize the audio for words such as “companyA.com” and then create a text based representation of the URL, as “companyA.com” to be loaded in a browser. By scanning the audio stream, URLs that are not presented in the closed-captioning stream can still be identified and loaded into the user's browser.

If a URL is identified in TV signal 105, enhanced TV device 10 can direct computer 120 to load the URL in browser 125. If browser 125 supports tabbed browsing, the URL can be loaded in a new tab in browser 125. Computer 120 can be a computer, laptop, personal digital assistant, or other portable device. Computer 120 includes typical elements of a computer, such as a central processor, memory, bus, disk space, etc. Computer 120 and enhanced TV device 110 can be connected by a network (not shown in FIG. 1) that can utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

In some embodiments of the invention, computer 120 can include a TV tuner to enable the monitor of computer 120 to display the broadcast transmitted by TV signal 105. In this embodiment, TV signal 105 can be input into computer 120. In addition, in some embodiments of the invention, enhanced TV device 110 can be installed on computer 120 and perform the functions as described above. Thus, for example, it is possible that computer 120 can include all the necessary hardware and/or software to perform all of the functions described above, without requiring any externally separate hardware.

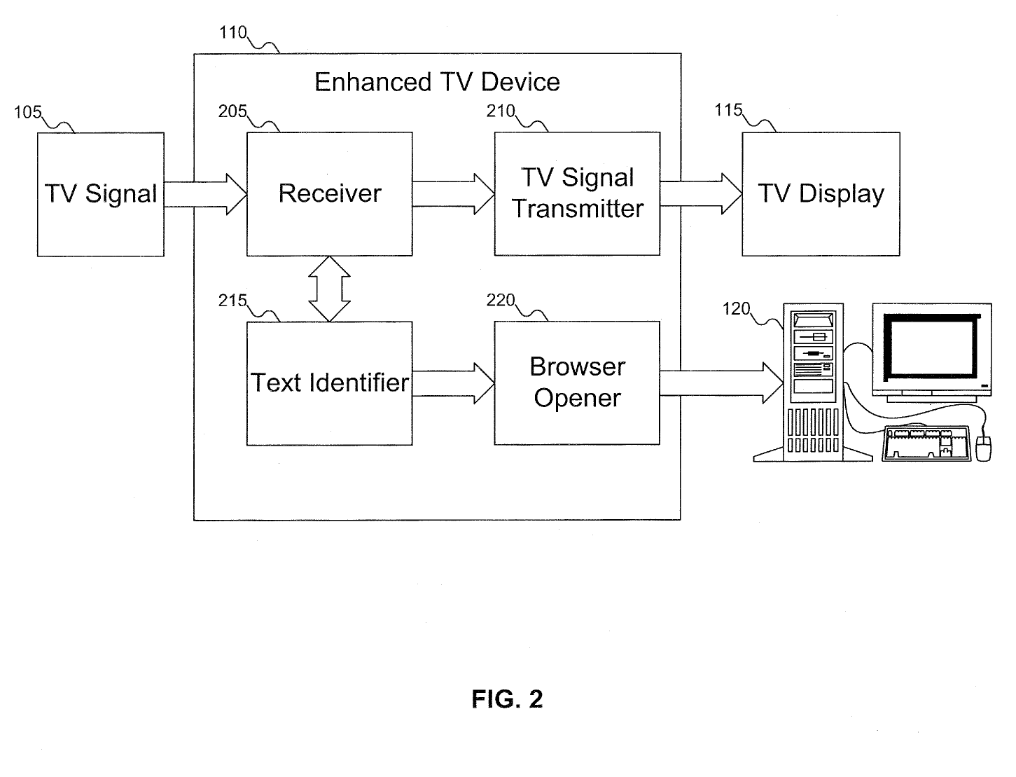

FIG. 2 shows components of the enhanced TV device shown in FIG. 1. Enhanced TV device 205 includes TV signal receiver 205 to receive TV signal 105. TV signal transmitter 210 then transmits TV signal 105 to display 115. Enhanced TV device 10 also includes text identifier 215 that is able to identify text in TV signal 105. In an embodiment of the invention, text identifier 215 scans ancillary data, such as a closed-captioning stream or a sideband channel of TV signal 105. In another embodiment of the invention, text identifier 215 scans the audio stream of TV signal 105 using voice recognition techniques. When text identifier 215 identifies a URL in TV signal 105, browser opener 220 is triggered to direct computer 120 to load the identified URL in a browser. Although FIG. 2 shows each of the components of enhanced TV device 110 as separate components, a person skilled in the art will recognize that some of the components can be combined together, or additional components can also be in enhanced TV device 110.

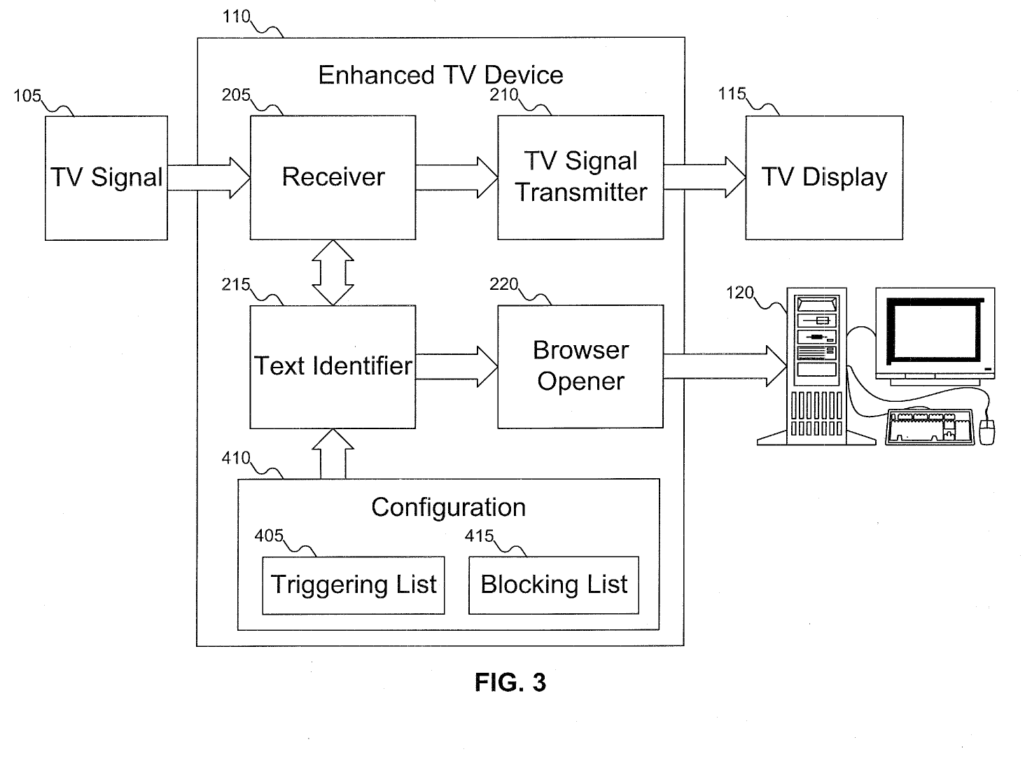

FIG. 3 shows the enhanced TV device of FIG. 2 with configuration data including triggering words and blocking words. Configuration 410 includes settings that allow users to specify the types of URLs to open a browser to, or settings enabling users to prevent the loading of a detected URL in a browser. For example, one user might desire that all identified URLs be loaded in a web browser, while other users might instead like to have some control over the URLs that get loaded.

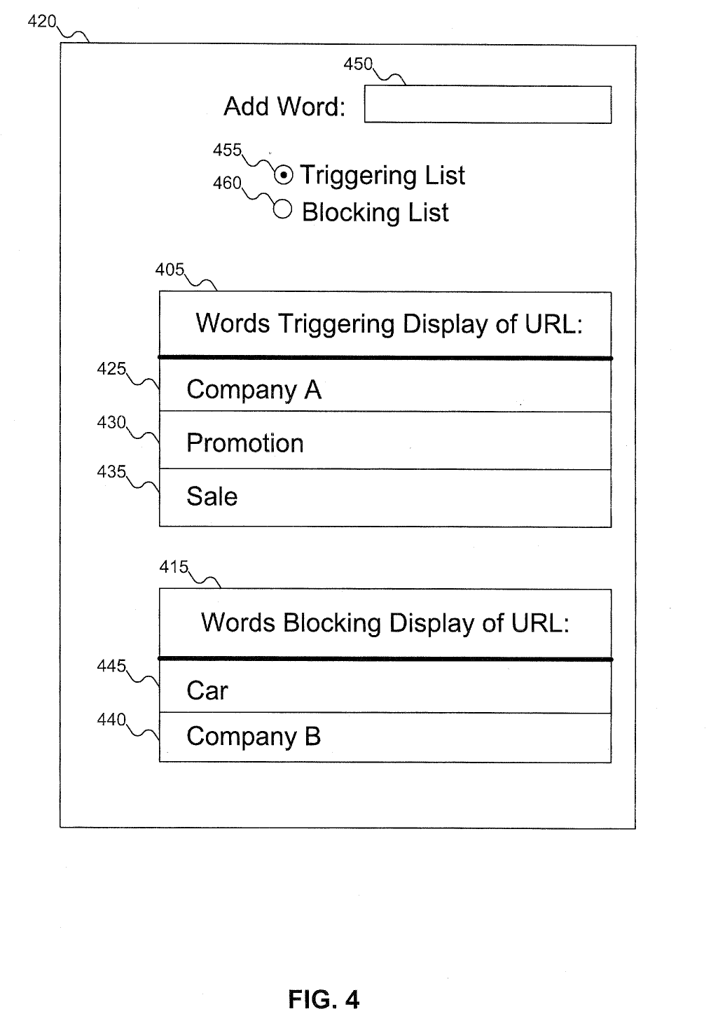

In some embodiments of the invention, a user can enter words into triggering list 405, so that when a word in triggering list 405 is identified in the TV signal, a URL is loaded. A user can also use blocking list 415 to prevent a URL from being loaded. The use of triggering list 405 and blocking list 415 are optional. In an embodiment of the invention, if no words are entered into either list, then all identified URLs are loaded in an Internet browser for the user. The use of triggering list 405 and blocking list 415 are discussed in greater detail below with reference to FIG. 4.

FIG. 4 shows a configuration interface for the enhanced TV device of FIG. 3 with words entered for triggering and blocking the display of a URL. Configuration interface 420 shows words included in triggering list 405 and blocking list 415. By showing the user what words are included in which list, the user is able to track how enhanced TV device 110 works to open up a URL identified in a TV broadcast in a web browser.

If triggering list 405 includes at least one word and blocking list 415 is empty, then URLs that are appropriately near the words included in triggering list 405 are loaded in a browser. For example, a user might prefer that a URL be loaded only when a particular company name is identified near the URL, and all other URLs should be ignored. The user can enter “Company A” in triggering list 405 as shown in entry 425. Or a user might be interested in all URLs that are related to a sale or a promotion. These words are shown in entries 430 and 435 in triggering list 405. As a URL is identified in the TV broadcast stream, the TV broadcast stream can be investigated further to see if the word “sale” or “promotion” is included near the URL. In this example, it is less important to the user who is offering the sale, than the mere fact that there is a sale. If a word from triggering list 405 is included in the URL, then the URL is loaded in a browser on computer 120.

In another embodiment of the invention, a user might want to receive most URLs, but not all URLs. If blocking list 415 is used and triggering list 405 is not used, then a URL is loaded provided that no words in blocking list 415 are identified near the URL. Use of blocking list 415 without using triggering list 405 allows the loading of all URLs that do not have a word listed in blocking list 415 in or near the URL. For example, a user might be interested in not seeing web content for a particular company or on a particular product. By using blocking list 415, the user can filter out URLs based on entry of the company or product entered in blocking list 415. Suppose a user has had a negative experience with a product from Company B, and has no interest in receiving any new information for this product. This user can add “Company B” to blocking list 415 as shown in entry 440. Then, when a URL is identified in the TV broadcast stream near “Company B”, rather than loading the URL in a browser on computer 120, the enhanced TV device instead takes no action.

In an embodiment of the invention, if both triggering list 405 and blocking list 415 are used, a URL is loaded if there is a triggering word near the URL, as long as there is also not a blocking word near the URL. In this embodiment, the words in blocking list 415 trump the words in triggering list 405. For example, a URL can be identified in a closed-captioning stream near the words “car” and “sale”. Although “sale” is included in entry 435 of triggering list 405, “car” is included in entry 445 of blocking list 415. In an embodiment where words in blocking list 415 trump words in triggering list 405, then the proximity of “car” to the URL means that the URL is not loaded, even though the word “sale” is also near the URL.

However, a user might prefer that in some instants a word in triggering list 405 always triggers the loading of a URL that is near that word. In another embodiment of the invention, the user can identify a word in triggering list 405 as being one that always triggers the loading of URL, even if there is a blocking word that would normally block the loading of the URL. For example, “Company A” as represented by entry 425 can be specified to always trigger the loading of a URL. If a URL is then identified near the words “Company A” and “Company B”, then the URL is loaded into a browser in this configuration. Note that a setting allowing all entries in triggering list 405 to trump entries in blocking list 415 would in effect produce the same results as a configuration with words entered into triggering list 405 and not blocking list 415.

Another example can further illustrate how configuration interface 420 can be used to identify the URLs the user is most interested in having loaded on the user's browser. If a user is interested in Web content for one department store, and not interested in Web content for another department store, the first department store can be entered in triggering list 405. It would then not be necessary to enter the other department store name in blocking list 415. However this configuration would also mean that only the URLs near the name of the first department store have URLs loaded, and no other URLs are loaded in the user's Internet browser.

But if the user would like to have other URLs also loaded in the browser, instead of adding the first company name to triggering list 405, the user can add the second company name to blocking list 415. By configuring enhanced TV device in this manner, the user prevents URLs that are near the second company name from being loaded, but still allows URLs with or near the first company name to be loaded. In addition, any other URLs that may or may not be related to department stores are still loaded in the browser on computer 120.

In an embodiment of the invention, the words in triggering list 405 and blocking list 415 can be embedded in the URL or near the URL. Although not shown in FIG. 4, configuration interface 420 can include a setting specifying how close to a URL a triggering word or blocking word is to be in order to initiate the triggering or blocking of the loading of the URL. In an embodiment of the invention, the user can even specify a number indicating the proximity of a word in on one of the lists to the URL. For example, a default setting could provide that a word within five words to a URL is close enough to the URL to implicate the loading or blocking of the URL. A particular word in triggering list 405 can then be also be configured so that if that word is within ten words of the URL, the URL should be loaded into a browser.

In an embodiment of the invention, a thesaurus can be used to identify words that are similar to the words in triggering list 405 (or blocking list 415). A user can identify words where use of a thesaurus is appropriate. For example, if the word “car” in entry 435 of blocking list 415 is marked to use the thesaurus, then it is unnecessary to also add the words “auto” or “vehicle” to blocking list 415. Words in triggering list 405 can similarly employ the use of the thesaurus. In addition, configuration interface 420 can allow a user to utilize the thesaurus for each entry in triggering list 405 and 415, or a user select individual words where the use of a thesaurus would be appropriate.

Finally, configuration interface 420 includes entry field 450 for users to add words to triggering list 405 and 415. For example, a user can enter the word that is to be added, and select either radio button 455 or radio button 460, depending on the list the word should be added to. Of course, this is but one example user interface. In another embodiment, a word can be added directly to the appropriate list for the word. A person skilled in the art will recognize other means of adding a word to triggering list 405 and blocking list 415 that can also be employed.

In an embodiment of the invention configuration interface 420 can be shown on the display used to present the TV broadcast to the viewer. In this embodiment, a user can interact with configuration interface 420 by using a remote control. The remote control can enable a user to move between fields, as well as enable the user to enter words in triggering list 405 and blocking list 415 by selecting letters shown on the display. In another embodiment, configuration interface 420 can be presented to the user via the user's computer. The user can then use standard input/output devices such as a keyboard and mouse to interact with configuration interface 420.

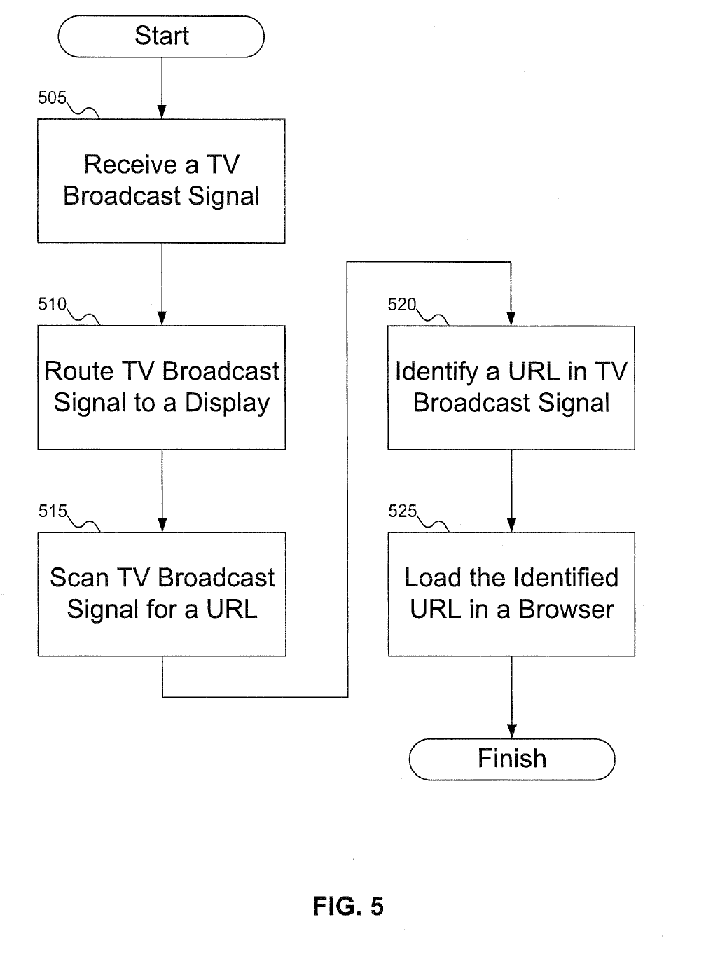

FIG. 5 shows a flowchart of the process of the enhanced TV device of FIG. 1 for detecting a URL in ancillary data of a TV broadcast signal and opening up a web page for the detected URL in a browser. At step 505, a TV broadcast signal is received. At step 510, the TV broadcast signal is routed to a display. At step 515, the TV broadcast signal is scanned for identification of a URL. Note that while step 510 is shown as occurring before step 515, in practice both steps can occur effectively simultaneously. Also, the routing step 510 and the scanning a URL step 515 are both perpetual processes, rather than steps that are performed once and then considered complete. At step 520, a URL is identified in the TV broadcast signal. In an embodiment of the invention, the URL is identified in ancillary data of the TV broadcast signal, such as closed-captioning. In another embodiment of the invention, the URL is identified by using voice recognition techniques on the audio stream. After a URL is identified, at step 525 the URL is launched in a browser. The URL can be loaded in a browser and presented to the user on the display for the TV broadcast, or in a display for a computer. In addition, in an embodiment of the invention, an instance of an Internet browser can be opened with the URL. In another embodiment of the invention, if there is already a browser running on the computer and the browser supports tabbed browser, the browser can load the URL in a new tab. A person skilled in the art will recognize that there are other ways for a URL to be loaded in a browser.

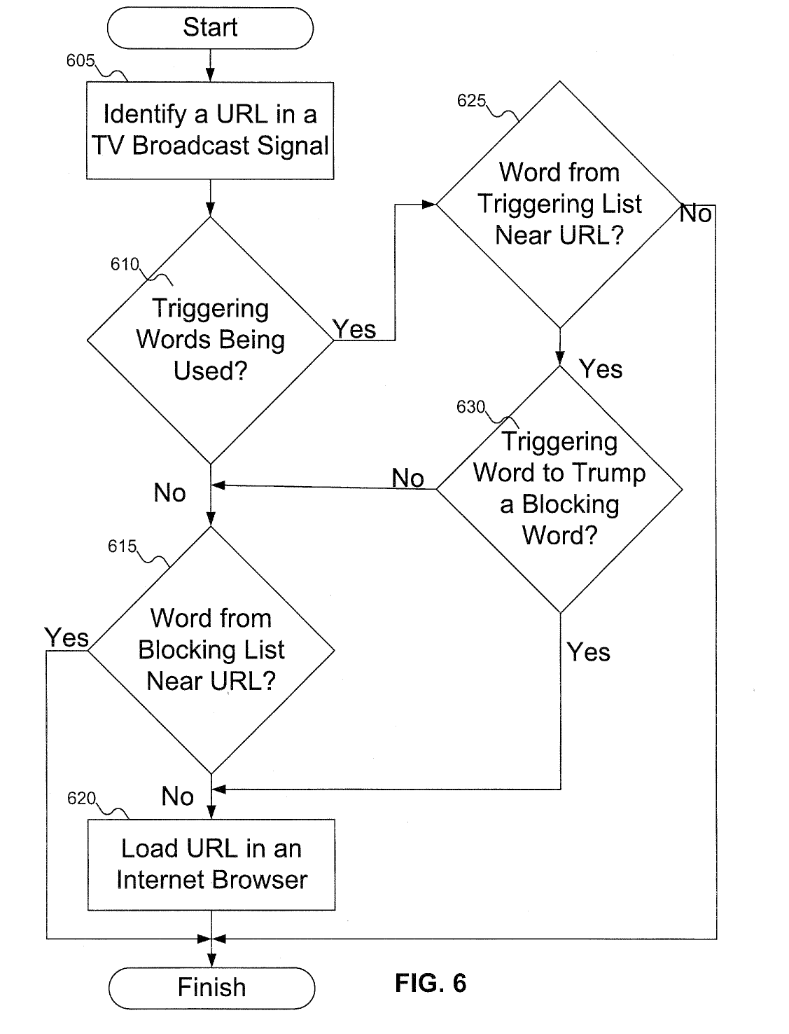

In contrast to FIG. 5 which shows a process where all identified URLs are loaded into a browser, FIG. 6 shows a flowchart of the process where triggering words and blocking words are used to filter the URLs that are loaded in the browser. As previously described with reference to FIGS. 3-4, a user can use triggering words to identify a subset of identified URLs for loading. Or a user can use blocking words to identify a subset of identified URLs that should not be displayed. Although not shown, steps 505-515 from FIG. 5 are performed in the flowchart of FIG. 6. Then, like step 520 shown in FIG. 5, at step 605, a URL is identified in a TV broadcast signal.

Decision block 610 determines if triggering words are being used to identify what URLs should be opened in a user's web browser. For example, there can be a configuration setting that determines the use of triggering words. Or the configuration of the enhanced TV device can be set up so that if there are no words in the triggering list, then triggering words are not used. If at decision block 610 triggering words are not being used, then at decision block 615, it is determined if any words from the blocking list are identified near the URL. In an embodiment of the invention, a blocking word can have a default proximity to the URL that will put the force of the blocking word into effect or the user can specify in the configuration how near the blocking word should be to the URL. If at decision block 615 there is no word from the blocking list, then at step 620 the URL is loaded in the Internet browser. However, if at decision block 615 a word from the blocking list is identified near the URL, then the process finishes without the URL being loaded in the browser.

Returning to decision block 610, if triggering words are being used, then decision block 625 determines if a word from the triggering list is identified near the URL. As with the blocking words, a default proximity of a word to a URL can be used, or a user can specify how near to the URL a word should be in order to trigger the loading of a URL. If at decision block 625 no words from the triggering list are identified near the URL, then the process finishes without loading the URL in the browser. However, if at decision block 625 a word from the triggering list is identified near the URL, then the process continues at decision block 630.

At decision block 630, if the triggering word is set up to trump any blocking word, then the process continues at step 620 where the URL is loaded in an Internet browser. Recall that a user can configure the enhanced TV device to provide that the identification of a word in the triggering list is to trigger the loading of a URL regardless of whether a word in the blocking list is identified near the URL. If, at decision block 630, the triggering word does not trump any blocking word, then the process continues at decision block 615 where the enhanced TV device determines if there is a blocking word near the URL as discussed above.

After the URL is loaded in a browser at step 620, the process involving that particular URL is complete. However, in practice the procedure outlined in FIG. 6 is ongoing, and additional URLs might be identified in the TV broadcast. As another URL is identified, the process begins anew at step 605.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciated that network communication may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles. And although the foregoing discussion has focused on particular embodiments and examples, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A system for identifying web content from a televised broadcast, comprising:
a computer including a browser;
a display;
an enhanced television (TV) device capable of receiving a TV broadcast signal, the enhanced TV device to detect a uniform resource locator (URL) in the TV broadcast signal, to deliver the TV broadcast signal to the display, and to direct the computer to load the detected URL in the browser.

2. A system according to claim 1, further comprising a configuration interface to enable a viewer to configure the enhanced TV device.

3. A system according to claim 2, wherein the configuration interface in the enhanced TV device includes a triggering list including at least one word that when the one word is detected in the TV broadcast signal, the enhanced TV device directs the computer to load the URL in the browser.

4. A system according to claim 2, wherein the configuration interface in the enhanced TV device includes a blocking list including at least one word that when the one word is detected in the TV broadcast signal, the enhanced TV device does not direct the computer to load the URL in the browser.

5. A system according to claim 2, wherein the configuration interface is presented to the viewer on the display.

6. A system according to claim 2, wherein the configuration interface is presented to the viewer on a second display.

7. A system according to claim 1, wherein the enhanced TV device to direct the computer to load the detected URL in the browser on the display.

8. A system according to claim 1, wherein the enhanced TV device to direct the computer to load the detected URL in the browser on a second display.

9. A system according to claim 1, wherein the enhanced TV device is to detect a URL in an ancillary data of the TV broadcast signal.

10. A system according to claim 9, wherein the ancillary data of the TV broadcast signal is a closed captioning stream.

11. A system according to claim 1, wherein the enhanced TV device is to detect a URL in an audio stream of the TV broadcast signal.

12. A computer-implemented method for detecting a uniform resource locator (URL) in a television (TV) broadcast signal, comprising:
receiving the TV broadcast signal;
routing the TV broadcast signal to a display;
identifying the URL in the TV broadcast signal; and
signaling a computer to load the identified URL in a browser.

13. A method according to claim 12, further comprising receiving a configuration controlling the signaling the computer to load the identified URL in the browser.

14. A method according to claim 13, wherein:
receiving a configuration includes:
receiving a triggering word; and
adding the triggering word to a list of triggering words; and
signaling a computer to load the identified URL in a browser includes identifying the triggering word in the TV broadcast signal before signaling the computer to load the identified URL in a browser.

15. A method according to claim 13, wherein:
receiving a configuration includes:
receiving a blocking word; and
adding the blocking word to a list of blocking words; and
the method further comprises:
identifying the blocking word in the TV broadcast signal; and
blocking the signaling of a computer to load the identified URL in a browser.

16. A method according to claim 12, wherein identifying the URL in the TV broadcast signal includes identifying the URL in an ancillary data stream of the TV broadcast signal.

17. A method according to claim 16, wherein identifying the URL in an ancillary data stream includes identifying the URL in a closed captioning stream.

18. A method according to claim 12, wherein identifying the URL in the TV broadcast signal includes identifying the URL in an audio stream of the TV broadcast signal.

19. An apparatus, comprising:
a receiver to receive a television (TV) broadcast signal;
an identifier to identify a uniform resource locator (URL) in the TV broadcast signal;
a transmitter to transmit the TV broadcast signal to a display; and
a means for directing a computer to load the identified URL in a browser.

20. An apparatus according to claim 19, further comprising a memory to store a configuration.

21. An apparatus according to claim 20, wherein the configuration includes a triggering word that when the triggering word is identified in the TV broadcast signal, the computer is directed to load the identified URL in a browser.

22. An apparatus according to claim 20, wherein the configuration includes a block URL detection word that when the block URL detection word is identified in the TV broadcast signal, the computer is not directed to load the identified URL in a browser.

23. An apparatus according to claim 19, wherein an identifier to identify a URL in the TV broadcast signal includes an identifier to identify a URL in an ancillary data in the TV broadcast signal.

24. An apparatus according to claim 23, wherein the ancillary data is a closed captioning signal.

25. An apparatus according to claim 19, wherein an identifier to identify a URL in the TV broadcast signal includes an identifier to identify a URL in an audio stream in the TV broadcast signal.

26. An article, comprising a storage medium, said storage medium having stored thereon instructions, that, when executed by a machine, result in:
receiving a TV broadcast;
routing the TV broadcast to a display;
identifying a URL in the TV broadcast; and
signaling a computer to load the identified URL in a browser.

27. An article according to claim 26, further comprising receiving a configuration controlling the signaling the computer to load the identified URL in a browser.

28. An article according to claim 26, wherein:
receiving a configuration includes:
receiving a triggering word; and
adding the triggering word to a list of triggering words; and
signaling a computer to open a browser to the identified URL includes identifying the triggering word in the TV broadcast before signaling the computer to load the identified URL in the browser.

29. An article according to claim 26, wherein:
receiving a configuration includes:
receiving a blocking word; and
adding the block word to a list of block words; and
the method further comprises:
identifying the blocking word in the TV broadcast signal; and
blocking the signaling of a computer to load the identified URL.

30. An article according to claim 26, wherein identifying the URL in the TV broadcast includes identifying the URL in an ancillary data stream of the TV broadcast.
